(19) United States
(12) Patent Application Publication
(10) Pub. No.: US 2008/0016229 A1
(43) Pub. Date: Jan. 17, 2008

(54) METHOD AND SYSTEM OF RUNNING VIRAL ADVERTISEMENT SERVICE

(75) Inventor: JONG WON LEE, SEONGNAM-SI (KR)

Correspondence Address: KNOBBE MARTENS OLSON & BEAR LLP, 2040 MAIN STREET, FOURTEENTH FLOOR, IRVINE, CA, 92614, US

(73) Assignee: NHN CORPORATION, SEONGNAM-SI (KR)

(21) Appl. No.: 11/769,551

(22) Filed: Jun. 27, 2007

(30) Foreign Application Priority Data
Jun. 28, 2006 (KR) 10-2006-0058523

(51) Int. Cl. G06F 15/16; G06Q 40/00

(52) U.S. Cl. 709/229; 705/35; 705/35

(57) ABSTRACT

Disclosed is a method of running a viral advertisement service. The method includes providing a viral advertisement package for distributing via a computer network. The package has a playable content and a software module. Upon playing the playable content in a computing device, the software module is executed and sends a signal to a designated computer via the computer network. The signal indicates that the playable content is played in the computing device. The method further includes monitoring receipt of the signal by the designated computer from the remote computing device and computing a charge for the advertisement service based on the receipt of the signal is provided.

### CROSS-REFERENCE TO RELATED APPLICATION

This application claims the benefit of Korean Patent Application No. 10-2006-0058523, filed on Jun. 28, 2006, in the Korean Intellectual Property Office, the disclosure of which is incorporated herein by reference in its entirety.

### BACKGROUND

1. Field

The present disclosure relates to advertisement services in the Internet context, and more particularly, viral advertisement services.

2. Discussion of Related Technology

A banner advertisement in the Internet context refers to a type of advertisements in which a content promoting goods and services is displayed in the form of a graphic image in a predetermined portion of a webpage. The banner advertisement is in the shape of a banner and puts an advertisement in a predetermined format using a moving image file, and the like, and charges fess for the advertisement. To analyze advertising effects, the number of times that the advertisement banner is displayed for users and the number of times that a graphic image of the banner advertisement is downloaded for a predetermined period of time may be calculated and sent to an advertiser.

In its initial stage, the banner advertisement was a simple form of promoting a business content in a rectangular shape. However, the banner advertisement is currently using various technologies, for example, including a video or displaying a banner on a fixed location of a screen when a webpage or homepage is being viewed.

The banner advertisement is generally charged based on cost per mill (CPM). CPM refers to a rate that is charged to the advertising service subscriber (advertiser) when an Internet user is viewing a banner advertisement one thousand times. Accordingly, if CPM is 100 Korean Won, the advertisement services charges 100 Korean Won to the advertiser for the display of the advertisement content one thousand times on some Internet users' screens.

Unlike the banner advertisement, viral advertisement marketing or virus advertisement marketing refers to a marketing technique which enables Internet users to promote a company or products of the company by propagating certain multimedia contents (although not limited thereto) about the company or products using emails or other Internet communication channels or media. The viral advertisement marketing is named as such since the advertisement may be distributed like a computer virus. Also, the viral advertisement marketing has been highlighted as a new Internet advertisement technique since the end of the year of 2000. Since the viral advertisement may be promoted to consumers without the company's direct participation, the viral advertisement is different from existing advertisement methods.

Companies generally produce new and interesting contents to satisfy Internet users while following fashion, trends, and the like, and place the contents on Internet websites, and the like, for free. Through the above operation, the companies may include company names or products in the contents, thereby indirectly advertising the company names or the products.

When Internet users read an interesting content, they generally transmit the content to other Internet users via emails or other media. Through the repeating operation, marketing may be effectively performed. The viral advertisement marketing may be based on a web animation technology. In this instance, a file size is comparatively smaller, and the file may require the real time payment. Also, since the content may be produced in a simple way, promotion costs may be inexpensive.

The foregoing discussion in this section is to provide general background information, and does not constitute an admission of prior art.

### SUMMARY

An aspect of the invention provides a method of running a viral advertisement service, the method comprising: providing a viral advertisement package for distributing via a computer network, the package comprising a playable content and a software module, wherein upon playing the playable content in a computing device, the software module is configured to be executed and send a signal to a designated computer via the computer network, wherein the signal indicates that the playable content is played in the computing device; monitoring receipt of the signal by the designated computer from the remote computing device; and computing a charge for the advertisement service based on the receipt of the signal.

In the foregoing method, the package may further comprise an advertisement of a commodity, wherein the advertisement may be configured to be played along with the playable content. The charge may be computed based on the number of receipts of signals indicative of playing the playable content in computing devices. The software module may be further configured to update a generation of the package, which indicates the number of previous closings of the package until the package is stored in the computing device where the playable content is played. The charge may be computed further based on the generation of the package. The charge may be computed using varying rates for different generations, wherein the rate may be greater when the generation is greater. The signal further may comprise an address of a computing device where the playable content is played, wherein the charge may be computed further based on the address of the computing device. The method may further comprise determining whether the computing device is associated with the advertising service based on the address, wherein the charge may be computed using a first rate and a second rate greater than the first rate, wherein the first rate may be used in computing the charge when the computing device is associated with the advertisement service, and wherein the second rate may be used when the computing device is not associated with the advertisement service.

Still in the foregoing method, the playable content may be selected from the group consisting of a still image, a moving image, a sound recording, text and a combination of at least two of the foregoing. The method may further comprise monitoring transmission of the package from one location to another, wherein transmission may be monitored based on information from the software module indicating that the package is stored in a medium after the transmission, wherein the charge may be computed further based on monitoring of the transmission.

Another aspect of the invention provides a system for a viral advertisement service, the system comprising: a viral advertisement package providing module configured to place a viral advertisement package to be cloned or distributed via a computer network, the package comprising a playable content and a software module, wherein upon playing the playable content in a computing device, the software module is configured to be executed and send a signal to a designated computer via the computer network, wherein the signal indicates that the playable content is played in the computing device; and a charge computing module configured to compute a charge for the advertisement service based on receipt of the signal by the designated computer from the remote computing device.

Yet another aspect of the invention provides a method of running a viral advertisement service, the method comprising: providing a viral advertisement package for distributing via a computer network, the package comprising a playable content and a software module, wherein once the package has been cloned, the software module is configured to determine that the package has been cloned and send a signal to a designated computer via the computer network, wherein the signal is configured to indicate that the package is cloned in the computing device; monitoring receipt of the signal by the designated computer from the remote computing device; updating a viral advertisement tracking database with the receipt of the signal, wherein the database comprises the number of clonings of the package; and computing a charge for the advertisement service based on the number of clonings.

In the foregoing method, the software module may be configured to send the signal upon playing of the playable content in the computing device. The signal may be further configured to indicate the address of the computing device, wherein the database may be further updated with the address, wherein computing the charge may be further based on the address.

A further aspect of the invention provides a system for a viral advertisement service, the system comprising: a viral advertisement package providing module configured to place a viral advertisement package to be cloned or distributed via a computer network, the package comprising a playable content and a software module, wherein once the package has been cloned, the software module is configured to determine that the package has been cloned and send a signal to a designated computer via the computer network, wherein the signal is configured to indicate that the package is cloned in the computing device; a database updating module configured to update a viral advertisement tracking database with receipt of the signal by the designated computer, wherein the database comprises the number of clonings of the package; and a charge computing module configured to compute a charge for the advertisement service based on the number of clonings.

Another further aspect of the invention provides a viral advertisement package for distribution in a computer network, the package comprising: a playable content in a computing device; an advertisement configured to be played upon playing the playable content; and a software module executable upon playing the playable content, wherein the software module is configured to send a signal to a designated computer via the computer network, wherein the signal indicates that the playable content is played in the computing device.

In the foregoing package, the signal may further comprise information indicative of the number of previous clonings of the package until the package is stored in the computing device where the playable content is played. The software module may comprise a counter configured to count the cloning of the package. The signal may further comprise information indicative of the address of the computing device where the playable content is played.

Yet another further aspect of the invention provides a method of running a viral advertisement service, the method comprising: providing a viral advertisement package for distributing via a computer network, the package comprising a playable content and a software module, wherein once the package has been cloned, the software module is configured to determine that the package has been cloned and send a signal to a designated computer via the computer network, wherein the signal is configured to indicate that the package is cloned in the computing device; monitoring receipt of the signal by the designated computer from the remote computing device; updating a viral advertisement tracking database with the receipt of the signal, wherein the database comprises the number of clonings of the package; and computing a charge for the advertisement service based on the number of clonings.

An aspect of the present invention provides a method of computing a charge associated with an online content, and a system for executing the method. Another aspect of the present invention provides a viral advertisement, capable of acquiring distribution information and location information of a content, in the content and acquiring the distribution information and the location information of the content distributed via the viral advertisement, and computing a charge for a viral advertisement marketing, a word of mouth (WOM) advertisement marketing, and the like. In this instance, the content is included in the viral advertisement marketing or the WOM advertisement marketing. Another aspect of the preset invention provides identification of a distribution degree or a utilization degree of a video, a sound source, an image, a program, and the like, with respect to a content, and compute a charge associated with the content as necessary.

An aspect of the present invention provides a method of running a viral advertisement service, the method including: providing a viral advertisement package for distributing via a computer network, the package comprising a playable content and a software module, wherein upon playing the playable content in a computing device, the software module is configured to be executed and send a signal to a designated computer via the computer network, wherein the signal indicates that the playable content is played in the computing device; monitoring receipt of the signal by the designated computer from the remote computing device; and computing a charge for the advertisement service based on the receipt of the signal.

In this instance, the package further comprises an advertisement of a commodity, wherein the advertisement is configured to be played along with the playable content. Also, the charge may be computed based on the number of receipts of signals indicative of playing the playable content in computing devices. Also, the software module may be further configured to update a generation of the package, which indicates the number of previous closings of the package until the package is stored in the computing device where the playable content is played.

Another aspect of the present invention provides a system for a viral advertisement service, the system including: a viral advertisement package providing module configured to place a viral advertisement package to be cloned or distributed via a computer network, the package comprising a playable content and a software module, wherein upon playing the playable content in a computing device, the software module is configured to be executed and sends a signal to a designated computer via the computer network, wherein the signal indicates that the playable content is played in the computing device; and a charge computing module configured to compute a charge for the advertisement service based on receipt of the signal by the designated computer from the remote computing device.

### BRIEF DESCRIPTION OF THE DRAWINGS

The above and other aspects and advantages of the present invention will become apparent and more readily appreciated from the following detailed description, taken in conjunction with the accompanying drawings of which:

FIG. 1 is a diagram illustrating an example of viral advertisement marketing;

FIG. 2 is a diagram illustrating a system for running a viral advertisement service and computing a charge according to an exemplary embodiment of the present invention;

FIG. 3 is a flowchart illustrating a method of running a viral advertisement service and computing a charge according to an exemplary embodiment of the present invention;

FIG. 4 is a flowchart illustrating a method of acquiring and processing viral advertisement information according to an exemplary embodiment of the present invention;

FIG. 5 illustrates an example of a method of acquiring viral advertisement information based on cloning of a content according to an exemplary embodiment of the present invention;

FIG. 6 illustrates an example of a processing method depending upon playing or cloning of a content according to an exemplary embodiment of the present invention;

FIG. 7 is a flowchart illustrating a method of computing a charge for the viral advertisement using a content according to an exemplary embodiment of the present invention;

FIG. 8 illustrates an example of a method of computing a charge for the viral advertisement using a content according to an exemplary embodiment of the present invention; and

FIG. 9 is a block diagram illustrating an internal configuration of a viral advertisement service system according to an exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. Exemplary embodiments will be described below by referring to the accompanying drawings.

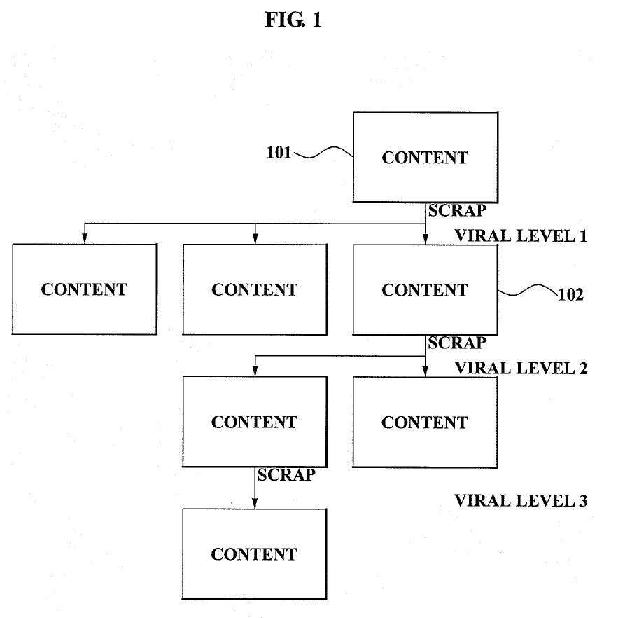

FIG. 1 is a diagram illustrating an example of the viral advertisement marketing. In the viral advertisement marketing, a company corresponding to an advertisement entity or an agency executing the viral advertisement marketing displays a content 101 on an Internet site, and the like. In this instance, the content 101 may be cloned, scrapped or downloaded by users accessing the content 101, and may be played in the same site or a different site. Also, a plurality of contents 102 played in the same site or the different site may be cloned, distributed, scrapped or downloaded by other users. Through the above operation or step, the plurality of contents 102 may be distributed to a large number of users. Also, a company name or a product included in the content 101 may be transferred to the larger number of users, and promoted.

However, in the viral advertisement marketing, when the agency produces a content and executes marketing of the content, it may be difficult to identify how much the content has been distributed and promoted. Also, it is difficult to create a standard to compute a charge associated with the content, which is different from the banner advertisement.

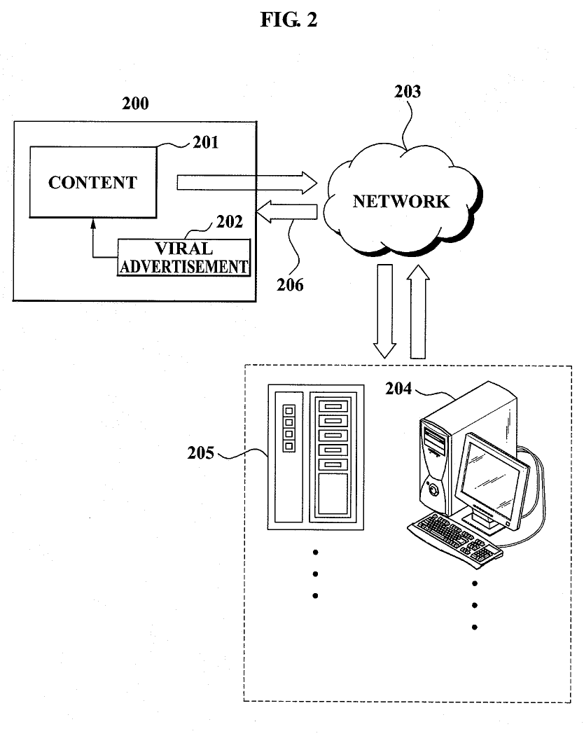

FIG. 2 is illustrates a system 200 for running a viral advertisement service and computing a charge according to an exemplary embodiment of the present invention. The viral advertisement system 200 provides a viral advertisement package 202 in a content 201, such as a video clip, a sound source, an image, and the like, and enables the content 201 to be distributed to a personal terminal 204, an Internet site server 205, and the like, via a network 203. In this instance, the viral advertisement package 202 is used to identify a distribution degree and a location of the content 201. Also, every time the distributed content 201 is played or cloned, the viral advertisement system 200 may receive viral advertisement information via the viral advertisement package 202 in operation 206, and compute the charge for the viral advertisement using the content 201 based on the viral advertisement information.

In one embodiment, the charge may be calculated in a process in which an agency, promoting an advertisement by including the advertisement in the content 201, computes a charge for promotion of the advertisement based on the viral advertisement information, which is the same as in a viral advertisement marketing or a word-of-mouth (WOM) marketing. The viral advertisement information is included in the viral advertisement package 202 and is used to acquire information about the distribution degree, the location, and a number of plays of the content 201. When the content 201 is cloned or scrapped, the viral advertisement information is cloned from the content 201 corresponding to a mother entity to the cloned or scrapped content and thus may include both information associated with the mother entity content 201 and information associated with the cloned content.

As described above, in an exemplary embodiment a viral advertisement package is provided. The viral advertisement system is capable of acquiring distribution information and location information of the distributed the viral advertisement package, and computing a cost or charge for the viral advertisement marketing, or the WOM advertisement marketing. In this instance, the content is included in the viral advertisement package or the WOM advertisement package.

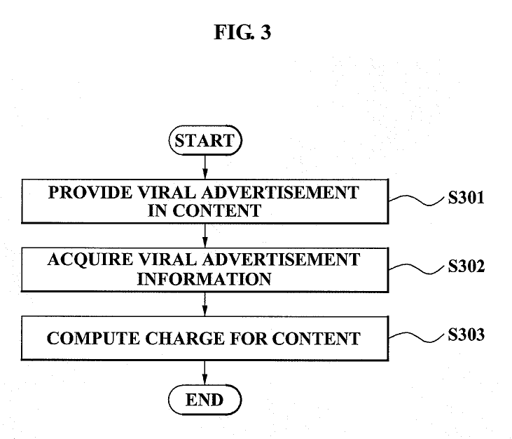

Hereinafter, a method of running a viral advertisement service using a content and computing a charge for the viral advertisement using the content based on distribution information and location information of the package including content will be described in detail with reference to FIGS. 3 through 8. FIG. 3 illustrates a method of running a viral advertisement service and computing a cost or charge in a viral advertisement system according to an exemplary embodiment of the present invention.

In operation S301, the viral advertisement system provides a viral advertisement package for tracking the included content. The viral advertisement system provides the viral advertisement in the content and performs the viral advertisement tracking via the viral advertisement package.

In operation S302, the viral advertisement system acquires viral advertisement information associated with the content using the viral advertisement module. As described above, the viral advertisement package may include a transmitting module which is configured to transmit the viral advertisement information to the viral advertisement system when the content is played. The package may further includes an updating module which is configured to update mother information the cloned content using the status information of the mother entity content, update the status information of the cloned content, and transmit the updated status information to the viral advertisement system when the system is cloned. In an embodiment, the status information of the content includes a viral level (VL), a viral number (VN), and location information.

Also, the viral advertisement information may include mother information and status information. The mother information refers to the information associated with the mother entity content. The mother information includes distribution information and location information of a content corresponding to the mother entity content. Also, the status information refers to the information associated with the cloned content. The status information includes distribution information and location information of the cloned content.

In an embodiment, the distribution information may include 1) a viral advertisement identifier identifying the content, 2) the VL indicating a distribution level of the content, and 3) the VN identifying the content in the same viral advertisement identifier and the same VL. Also, the location information may include an Internet Protocol (IP) address or a Universal Resource Locator (URL) corresponding to address information of a webpage in which the content is displayed.

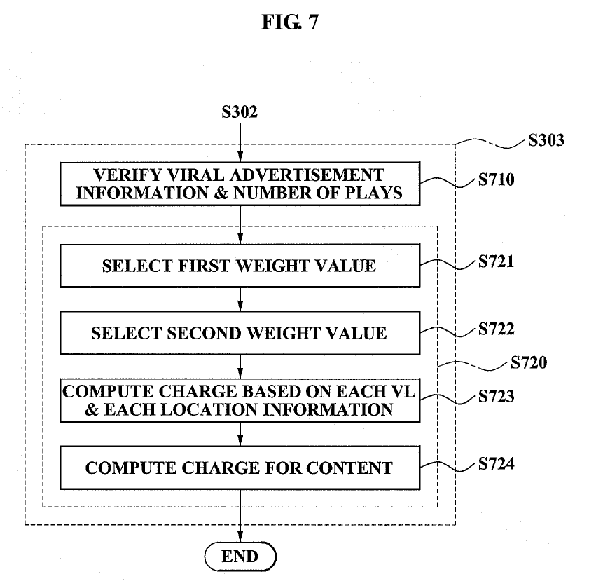

Referring to FIG. 3, in operation S303, the viral advertisement system computes a charge for the viral advertisement using the content based on the viral advertisement information. In an embodiment, the viral advertisement information may be utilized to compute the charge for the advertisement. A method of computing the charge associated with the content will be described in detail with reference to FIG. 7.

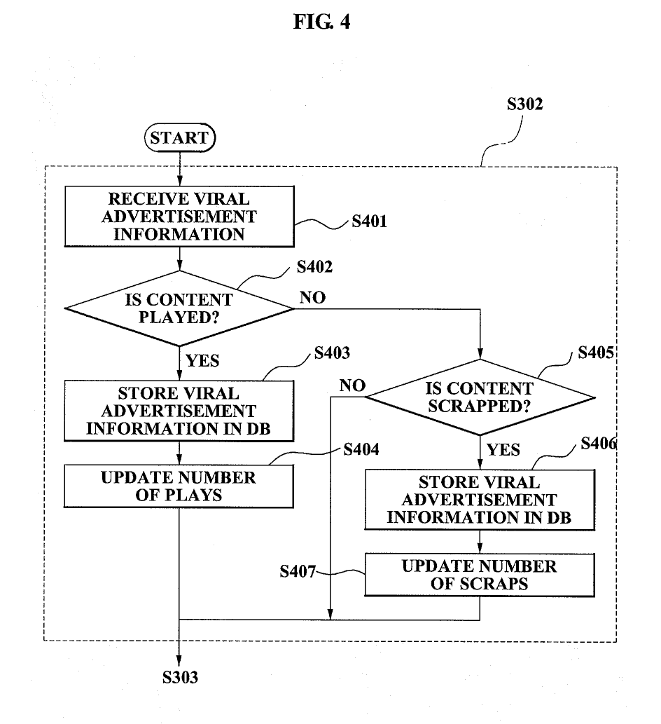

FIG. 4 is illustrates a method of acquiring and processing viral advertisement information according to an exemplary embodiment of the present invention. As shown in FIG. 4, operations S401 through S407 may be included in operation S302 of FIG. 3. In operation S401, the viral advertisement system receives viral advertisement information via the transmitting module or the updating module when the content is played or cloned.

In operation S402, the viral advertisement system verifies whether the viral advertisement information is transmitted based on playing of the content. In this instance, when the viral advertisement information is transmitted based on playing of the content, the viral advertisement system performs operation S403, otherwise, performs operation S405. In operation S403, the viral advertisement system stores the viral advertisement information in a database. In operation S404, the viral advertisement system updates the number of plays of the content based on the viral advertisement information. In this instance, operation S404 may include a process of classifying and updating the number of plays, based on the VL and the location information, with respect to all the packages having the same viral advertisement identifier.

In operation S405, the viral advertisement system verifies whether the viral advertisement information is transmitted based on cloning of the content. In this instance, when the viral advertisement information is transmitted based on cloning of the content, the viral advertisement system performs operation S406, otherwise, performs operation S303. In operation S406, the viral advertisement system stores the viral advertisement information in the database. In operation S407, the viral advertisement system updates the number of clonings of the content based on the viral advertisement information. In this instance, operation S407 includes a process of classifying and updating the number of clonings, based on the VL and the location information, with respect to all the packages having the same viral advertisement identifier.

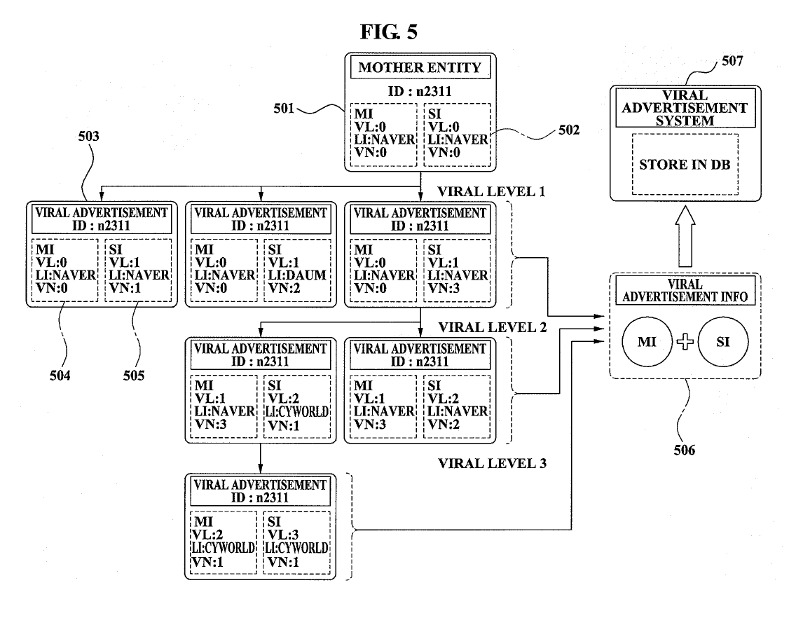

FIG. 5 illustrates an example of a method of acquiring viral advertisement information based on cloning of a content according to an exemplary embodiment of the present invention. As shown in FIG. 5, when a content is cloned, a viral advertisement mother module 501, which is a viral advertisement module provided in the content package, is cloned to the cloned content package. Accordingly, status information 502 is also cloned with the mother information 504 of a cloned viral advertisement module 503 and the viral advertisement module 503 updates status information 505 based on the mother information 504.

Specifically, a VL of the status information 505 is determined based on a VL of the mother information 504. Location information LI of the status information 505 is determined based on an IP address or a URL of a website in which the content is cloned and displayed. Also, a VN of the status information 505 is determined based on the order of the packages cloned from the same mother package to identify the cloned content with the same viral advertisement identifier and the same VL.

When the content is cloned as described above, the viral advertisement 503 transmits the viral advertisement information 505, including the mother information 504 and the status information 505, to the viral advertisement system 506. The viral advertisement system 506 stores the viral advertisement information 505 in the database, and updates a number of clonings of the content. In this instance, the number of clonings may be classified based on the VL and the location information, and then stored or updated.

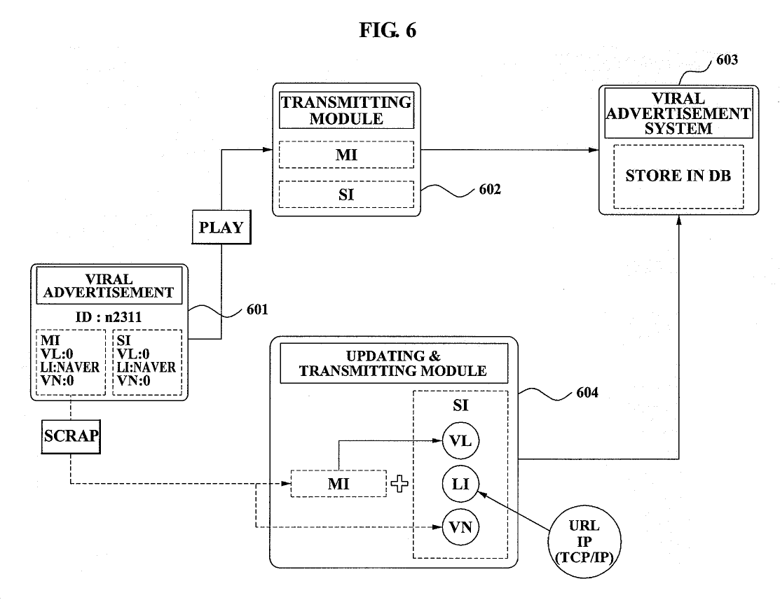

FIG. 6 illustrates an example of a processing method depending upon playing or cloning of a content according to an exemplary embodiment of the present invention. When the content is played, a viral advertisement 601 transmits viral advertisement information, including mother information and status information, to a viral advertisement system 603 by using a transmitting module 602. In this instance, the viral advertisement system 603 stores the viral advertisement information in a database, classifies the viral advertisement information based on a VL and location information of the status information, and then updates a number of plays of the content.

When the content is cloned, the viral advertisement module 601 is cloned in the cloned content. In this instance, the status information of the viral advertisement module 601 becomes the mother information of a new viral advertisement module. An updating module 604 included in the viral advertisement module 601 updates status information of the new viral advertisement based on the mother information. Also, location information is updated to an IP address or a URL of a website in which the cloned content is displayed. Also, every time the content is cloned, a VN sequentially increases for identifying new viral advertisement modules with the same viral advertisement identifier and the same VL.

As described above, viral advertisement information including the mother information and the status information of the new viral advertisement is transmitted to the viral advertisement system 603 by using the updating module 604. Also, the viral advertisement system 603 stores the viral advertisement information in a database, classifies the viral advertisement information based on VL and location information of the status information, and then stores or updates the number of clonings of the content. In this instance, when VL and location information of the content, which is not stored in the database, is transmitted, the number of clonings may be stored.

FIG. 7 is illustrates a method of computing a charge for the viral advertisement using a content according to an exemplary embodiment of the present invention. As shown in FIG. 7, operations S710 through S720 may be included in operation S303. In operation S710, the viral advertisement system verifies viral advertisement information and the number of plays of the content from a database storing the viral advertisement information. In this instance, the viral advertisement information is classified based on distribution information and location information of the viral advertisement information, and then stored in the database.

In operation S720, the viral advertisement system selects a content weight value referring the viral advertisement information, multiplies the content weight value to the number of plays, and computes the charge for the viral advertisement using the content. In this instance, operation S720 may include operations S721 through S724.

Specifically, in operation S721, the viral advertisement system selects a first content weight value based on a VL which is included in the distribution information. In operation S722, the viral advertisement system selects a second content weight value based on the location information. In operation S723, the viral advertisement system computes a viral advertisement cost or charge based on the number of plays, a charge based on a one-time play of the content, the first content weight value, and the second content weight value. In this instance, the viral advertisement charge may be defined as the following equation:

N×α×(βor Γ)×number of plays=viral advertisement charge, Equation 1

wherein N indicates the charge based on the one-time play of the content, α indicates the first content weight value based on the VL, and β and Γ indicates the second content weight value based on the location information. Also, β may indicate a weight value with respect to location information in which the content is initially displayed, and Γ may indicate a weight value with respect to location information excluding the above location information.

In operation S724, the viral advertisement system sums up the viral advertisement charges, thereby computing the charge for the viral advertisement using the content. Specifically, the viral advertisement system may compute the viral advertisement charge by applying the weight value based on the VL and the location information, sums up the viral advertisement charge of the content, thereby computing the charge for the viral advertisement using the content. As described above, it is possible to compute a charge for the viral advertisement marketing or a WOM advertisement marketing by acquiring distribution information and location information of a content, which is included in the viral advertisement package.

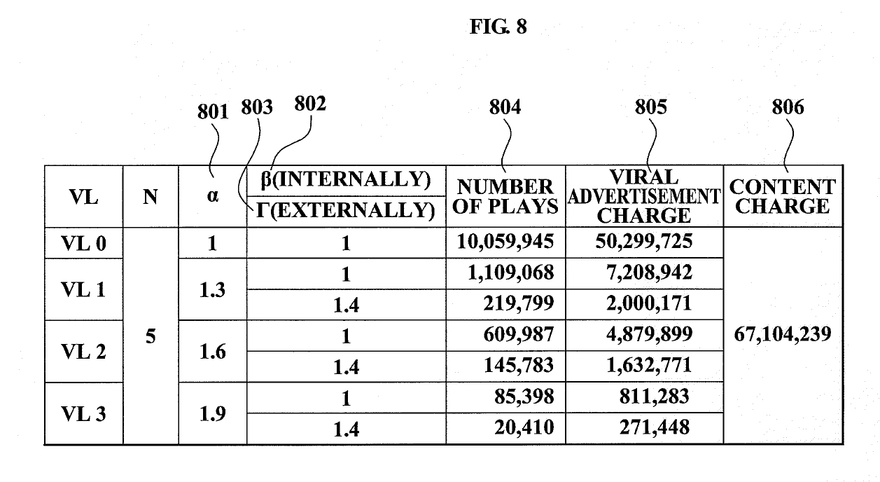

FIG. 8 illustrates an example of a method of computing a charge for the viral advertisement using a content according to an exemplary embodiment of the present invention. As shown in FIG. 8, a viral advertisement charge 805 may be computed based on a first content weight value 801, which is determined for each VL, second content weight values 802 and 803, which are determined for each location information, a number of plays 804, and a content charge 806 for a one-time play of the content, by using the calculating method of Equation 1, described above with reference to FIG. 7.

In this instance, the second content weight value 802 is associated with the plays that are classified as “internally” displaying based on the location information of a website, when the content is displayed in the website where the content is initially distributed. Also, the second content weight value 803 is associated with the plays that are classified as “externally” displaying based on the location information other than the website which the content is initially distributed.

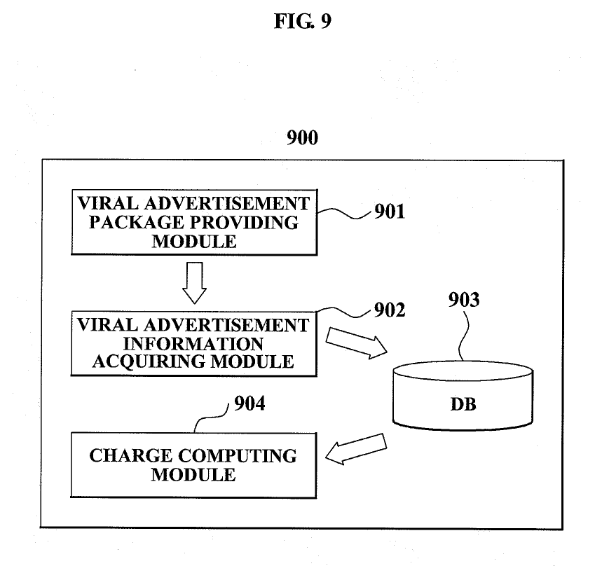

FIG. 9 is a block diagram illustrating an internal configuration of a viral advertisement service system 900 according to an exemplary embodiment of the present invention. As shown in FIG. 9, the viral advertisement system 900 may include a viral advertisement package providing module 901, a viral advertisement information acquiring module 902, a database 903, and a charge computing module 904. The viral advertisement package providing module 901 provides a viral advertisement module for a viral advertisement tracking to a content which is included in a viral advertisement package or a WOM advertisement package.

The viral advertisement information acquiring module 902 acquires viral advertisement information about the content via the viral advertisement. The viral advertisement module may include a transmitting module which is configured to transmit viral advertisement information to the viral advertisement system 900 when the content is played, and an updating module which is configured to clone the status information of the viral advertisement information referring to the mother information of a cloned content, update the status information of the cloned content, and transmit the updated status information to the viral advertisement system 900 when the system is cloned. In this instance, the status information of the content includes a VL, a VN, and location information.

As described above, the viral advertisement information may include mother information and status information. In this instance, the mother information includes distribution information and location information of the mother entity content. Also, the status information includes distribution information and location information of the cloned content.

In this instance, the distribution information may include 1) a viral identifier identifying the content, 2) the VL indicating a distribution level of the content, and 3) the VN identifying the content in the same viral identifier and the same VL. Also, the location information may include an IP address or a URL corresponding to address information of a webpage in which the content is displayed.

The viral advertisement information acquiring module 902 receives the viral advertisement information from the viral advertisement, when the content is played, stores the received viral advertisement information in the database 903, and updates a number of plays of the content. Also, when the content is cloned, the viral advertisement information acquiring module 902 may receive the viral advertisement information which is updated and transmitted via the viral advertisement module, and stores the received viral advertisement information in the database 903, and update the number of clonings of the content based on the viral advertisement information.

The charge computing module 904 computes the charge for the viral advertisement using the content based on the viral advertisement information. In this instance, the charge computing module 904 may verify the viral advertisement information and the number of plays associated with the content from the database 903, storing the viral advertisement information, select a content weight value from the viral advertisement information, assign the content weight value to the viral advertisement information, thereby computing the charge for the viral advertisement using the content.

Specifically, the charge computing module 904 may assign a first content weight value and a second content weight value to the number of plays, apply a charge of one-time play of the content using a multiply operation, thereby computing a viral advertisement charge. Also, the charge computing module 904 may sum up the viral advertisement charge, thereby computing the charge for the viral advertisement using the content. In this instance, the number of plays is classified based on distribution information and location information of the viral advertisement information, thereby storing the number in the database 903. Also, the first content weight value and the second content weight value are selected based on the location information and VL of the distribution information.

As described above, according to embodiments of the present invention, it is possible to provide a viral advertisement, capable of acquiring distribution information and location information of a content, in the content and acquire the distribution information and the location information of the content distributed via the viral advertisement, and computing a charge for the viral advertisement marketing, the WOM advertisement marketing, and the like. In this instance, the content is included in the viral advertisement marketing or the WOM advertisement marketing. Also, it is possible to identify a distribution degree or a utilization degree of a video, a sound source, an image, a program, and the like, with respect to a content, and compute a charge associated with the content as necessary.

The viral advertisement service method according to the above-described exemplary embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to embodiments of the present invention, it is possible to provide a viral advertisement, capable of acquiring distribution information and location information of a content, in the content and acquire the distribution information and the location information of the content distributed via the viral advertisement, thereby computing a charge for a viral advertisement marketing, a WOM advertisement marketing, and the like. In this instance, the content is included in the viral advertisement marketing or the WOM advertisement marketing.

Also, according to embodiments of the preset invention, it is possible to identify a distribution degree or a utilization degree of a video, a sound source, an image, a program, and the like, with respect to a content, and compute a charge associated with the content as necessary.

Although exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of running a viral advertisement service, the method comprising:
providing a viral advertisement package for distributing via a computer network, the package comprising a playable content and a software module, wherein upon playing the playable content in a computing device, the software module is configured to be executed and send a signal to a designated computer via the computer network, wherein the signal indicates that the playable content is played in the computing device;
monitoring receipt of the signal by the designated computer from the remote computing device; and
computing a charge for the advertisement service based on the receipt of the signal.

2. The method of claim 1, wherein the package further comprises an advertisement of a commodity, wherein the advertisement is configured to be played along with the playable content.

3. The method of claim 1, wherein the charge is computed based on the number of receipts of signals indicative of playing the playable content in computing devices.

4. The method of claim 1, wherein the software module is further configured to update a generation of the package, which indicates the number of previous closings of the package until the package is stored in the computing device where the playable content is played.

5. The method of claim 4, wherein the charge is computed further based on the generation of the package.

6. The method of claim 4, wherein the charge is computed using varying rates for different generations, wherein the rate is greater when the generation is greater.

7. The method of claim 1, wherein the signal further comprises an address of a computing device where the playable content is played, wherein the charge is computed further based on the address of the computing device.

8. The method of claim 7, further comprising determining whether the computing device is associated with the advertising service based on the address, wherein the charge is computed using a first rate and a second rate greater than the first rate, wherein the first rate is used in computing the charge when the computing device is associated with the advertisement service, and wherein the second rate is used when the computing device is not associated with the advertisement service.

9. The method of claim 1, wherein the playable content is selected from the group consisting of a still image, a moving image, a sound recording, text and a combination of at least two of the foregoing.

10. The method of claim 1, further comprising monitoring transmission of the package from one location to another, wherein transmission is monitored based on information from the software module indicating that the package is stored in a medium after the transmission, wherein the charge is computed further based on monitoring of the transmission.

11. A system for a viral advertisement service, the system comprising:
a viral advertisement package providing module configured to place a viral advertisement package to be cloned or distributed via a computer network, the package comprising a playable content and a software module, wherein upon playing the playable content in a computing device, the software module is configured to be executed and send a signal to a designated computer via the computer network, wherein the signal indicates that the playable content is played in the computing device; and
a charge computing module configured to compute a charge for the advertisement service based on receipt of the signal by the designated computer from the remote computing device.

12. A method of running a viral advertisement service, the method comprising:
providing a viral advertisement package for distributing via a computer network, the package comprising a playable content and a software module, wherein once the package has been cloned, the software module is configured to determine that the package has been cloned and send a signal to a designated computer via the computer network, wherein the signal is configured to indicate that the package is cloned in the computing device;
monitoring receipt of the signal by the designated computer from the remote computing device;
updating a viral advertisement tracking database with the receipt of the signal, wherein the database comprises the number of clonings of the package; and
computing a charge for the advertisement service based on the number of clonings.

13. The method of claim 12, wherein the software module is configured to send the signal upon playing of the playable content in the computing device.

14. The method of claim 12, wherein the signal is further configured to indicate the address of the computing device, wherein the database is further updated with the address, wherein computing the charge is further based on the address.

15. A system for a viral advertisement service, the system comprising:
a viral advertisement package providing module configured to place a viral advertisement package to be cloned or distributed via a computer network, the package comprising a playable content and a software module, wherein once the package has been cloned, the software module is configured to determine that the package has been cloned and send a signal to a designated computer via the computer network, wherein the signal is configured to indicate that the package is cloned in the computing device;
a database updating module configured to update a viral advertisement tracking database with receipt of the signal by the designated computer, wherein the database comprises the number of clonings of the package; and
a charge computing module configured to compute a charge for the advertisement service based on the number of clonings.

16. A viral advertisement package for distribution in a computer network, the package comprising:
a playable content in a computing device;
an advertisement configured to be played upon playing the playable content; and
a software module executable upon playing the playable content, wherein the software module is configured to send a signal to a designated computer via the computer network, wherein the signal indicates that the playable content is played in the computing device.

17. The package of claim 16, wherein the signal further comprises information indicative of the number of previous clonings of the package until the package is stored in the computing device where the playable content is played.

18. The package of claim 17, wherein the software module comprises a counter configured to count the cloning of the package.

19. The package of claim 16, wherein the signal further comprises information indicative of the address of the computing device where the playable content is played.

20. A method of running a viral advertisement service, the method comprising:
providing a viral advertisement package for distributing via a computer network, the package comprising a playable content and a software module, wherein once the package has been cloned, the software module is configured to determine that the package has been cloned and send a signal to a designated computer via the computer network, wherein the signal is configured to indicate that the package is cloned in the computing device;
monitoring receipt of the signal by the designated computer from the remote computing device;
updating a viral advertisement tracking database with the receipt of the signal, wherein the database comprises the number of clonings of the package; and
computing a charge for the advertisement service based on the number of clonings.
